(19) United States
(12) Patent Application Publication
(10) Pub. No.: US 2025/0012576 A1
(43) Pub. Date: Jan. 9, 2025

(54) METHODS AND SYSTEMS FOR TERRAIN-BASED LOCALIZATION OF A VEHICLE

(71) Applicant: ClearMotion, Inc., Billerica, MA (US)

(72) Inventor: William Graves, Somerville, MA (US)

(73) Assignee: ClearMotion, Inc., Billerica, MA (US)

(21) Appl. No.: 18/712,308

(22) PCT Filed: Nov. 23, 2022
(86) PCT No.: PCT/US2022/050852

§ 371 Date: May 22, 2024

Related U.S. Application Data
(60) Provisional application No. 63/282,781, filed on Nov. 24, 2021.

(51) Int. Cl. G01C 21/30; G01C 21/12

(52) U.S. Cl. CPC G01C 21/30; G01C 21/12

(57) ABSTRACT

Methods and systems are described for accurately determining the location of a vehicle traveling along a road. Methods include first locating the approximate position of a vehicle using techniques such as GNSS or dead reckoning from a know location, and then refining the position of the vehicle using terrain-based localization. This type of localization includes the use of the temporal and spatial variation of magnitude of the correlation between a current road surface profile, obtained while traveling along a road, and previously obtained reference profiles of the same road.

### RELATED APPLICATIONS

This application claims the benefit under 35 U.S.C. § 119 of U.S. provisional application 63/282,781, filed Nov. 24, 2021, the entire contents of which is incorporated herein by reference.

### FIELD

Disclosed embodiments are related to systems for terrain-based localization of a vehicle and related methods of use.

### BACKGROUND

Advanced vehicle features such as, for example, active suspension or autonomous or semi-autonomous driving may rely on accurate localization of a vehicle and/or road surface information. Localization-systems based on, for example, global navigation satellite systems (GNSS), may not provide sufficient accuracy or resolution in localization so that information about the road surface can be used effectively.

### SUMMARY

According to aspects of the disclosure, there is provided a method of accurately determining a current location of a vehicle traveling along a road. The method includes traveling along a first road segment, with a vehicle; receiving a current road-surface profile of the first road segment, where the first road segment terminates at the current location of the vehicle. The method further includes determining that the current location of the vehicle is within a zone of uncertainty of the localization system (e.g., GNSS, GPS), obtaining, from a data storage system (e.g., local RAM, remote database) reference road-surface profiles for a multiplicity of road segments, where each of the multiplicity of road segments is equal in length to the first road segment, and where each of the multiplicity of road segments has an endpoint located in the zone of uncertainty; comparing each of the multiplicity of reference road-surface profiles with the current road-surface profile; and determining an accurate current location of the vehicle, at least partially based on the comparisons.

In some embodiments, multiplicity may be a number greater than 2 but less than 20; and/or comparing may involve computing a magnitude of a correlation between each of the multiplicity of reference road-surface profiles and the current road surface profile. The method may further include determining a maximum of the computed correlations and determining the accurate current location of the vehicle to be the endpoint associated with the correlation with the maximum value. In some embodiments each reference road-surface profile may be at least partially based on crowd sourced data. In some embodiments, the comparing may involve using running averages of the current and/or reference data sets. In some embodiments the comparing may involve applying a filter to the current and/or reference data sets, where the filter may be an IIR filter. In some embodiments the current road-surface profile and a first reference road-surface profile may include an equal number of data points, and where the comparison may include determining a degree of similarity between at least the first reference road-surface profile and the current road-surface profile at least based on a running average of the squares of the data points in each of the first reference road-surface profile and the current road-surface profile.

According to aspects of the disclosure, there is provided a method of determining a current position of a vehicle relative to a road segment during a current traversal of the road segment. The method includes: receiving a current road surface profile for at least a portion of the road segment during the current traversal of a first road segment that terminates at the current position of the vehicle, where the current road surface profile data is at least partially based measurements with one or more sensors on-board the vehicle; receiving a pre-recorded road surface profile of a second road segment, where the second road segment at least partially overlaps but is longer than the first road segment; determining magnitudes of multiple correlations of the first road segment, with multiple subsets of the second road segment; and based on the comparison of the at least two magnitudes, determining the current position of the vehicle relative to the second road segment more accurately. In some embodiment the accuracy may be greater than is possible with various GNSS or dead reckoning systems.

According to aspects of the disclosure, there is provided a method for localizing a vehicle, that includes obtaining an approximate location of the vehicle e.g., with a GNSS system or a dead reckoning system; determining that the approximate location is within a threshold distance from a pre-determined point of a first road segment of a series of road segments, wherein the first road segment is associated with a previously stored first reference road surface profile; and comparing a current road surface profile with the first reference road surface profile and, based on the comparison, determining a first time-point at which the vehicle is located at the pre-determined point of the first road segment, thereby localizing the vehicle to the pre-determined point of the first road segment at the first time-point.

In some embodiments, the method may include obtaining the approximate location of the vehicle based at least in part on a Global Navigation Satellite System (GNSS) and or dead reckoning from a known location. In some embodiments the method may include obtaining for each road segment: the location of a pre-determined point of the respective road segment; and a reference road surface profile of the respective road segment. In some embodiments, the current road surface profile may be generated, where generating the current road surface profile includes measuring vertical motion of one or more portions of the vehicle as the vehicle operates. In some embodiments, in generating the current road surface profile may also include filtering the current vertical motion to remove effects of wheel-hop. In some embodiments generating the current road surface profile may also include transforming the current vertical motion from a time domain to a distance domain. The method may also include, where the comparison of the current road surface profile with the first reference road surface profile is carried out, in response to the determination that the approximate location is within a threshold distance of the pre-determined point of the first road segment. In some embodiments, the predetermined point is not an end point of a road segment.

According to aspects of the disclosure, there is provided a method of determining a location of a vehicle, while the vehicle is traveling along a road, that includes the following steps: (a) using a first vehicle localization system (e.g., GNSS, GPS, or dead reckoning) to determine that the vehicle is traveling within a predetermined threshold distance from a predetermined point in the road (e.g. endpoint, mid-point, or other identifiable point); (b) traveling, with the vehicle, within the predetermined threshold distance from the predetermined point in the road; and (c) during (b), determining the position of the vehicle using a second localization system; wherein the second localization system is a terrain-based localization system, and wherein the second localization system is more accurate than the first localization system. In some embodiments, step (c) of the method may include: obtaining a multiplicity of road surface profiles that terminate at a multiplicity of locations of the vehicle on the road; comparing each of the multiplicity of road surface profiles and a reference road surface profile that terminates at the predetermined point in the road; determining that the peak correlation of the comparisons is greater that a predetermined value; determining that the vehicle was effectively at the predetermined point when the road surface profile associated with the peak correlation was obtained.

According to aspects of the disclosure, there is provided a method of determining a location of a vehicle, while the vehicle is traveling along a road, that includes: receiving a reference road surface profile of the road from a data base; using a first localization system to estimate a current location of the vehicle relative to the reference road surface profile, where the first localization system (e.g., GNSS, GPS, or dead reckoning) has a zone of uncertainty; receiving a current road surface profile, based at least partially data from sensors onboard the vehicle, where the current road surface profile terminates at the vehicle's current position and is shorter than the reference road surface profile; selecting a multiplicity of segments of the reference road surface profile that are equivalent in length to the current road surface profile and terminate in the zone of uncertainty, where the terminations of the multiplicity of segments are distributed in the zone of uncertainty; comparing the current road surface profile with each of the multiplicity of segments; identifying a segment with a best correlation value; and determining the termination point of the segment of the road surface profile associated with the best correlation value to be the location of the vehicle when the best correlation value is greater than a predetermined threshold value. In some embodiments of the method, the terminations of the multiplicity of segments are distributed uniformly in the zone of uncertainty.

According to aspects of the disclosure, there is provided a method of determining a location of a vehicle, while the vehicle is traveling along a road, that includes: determining that the vehicle is traveling within a predetermined threshold distance from a predetermined point in the road, based on data from a first vehicle localization system (e.g., GNSS, GPS, or dead reckoning); determining the position of the vehicle using a second localization system, while traveling within the predetermined threshold distance from the predetermined point in the road (e.g. endpoint, mid-point, or other identifiable point), wherein the second localization system is a terrain-based localization system, and wherein the second localization system is more accurate than the first localization system.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts an embodiment of a road map including a road divided into a set of road segments;

FIG. 2 depicts a schematic of an embodiment of a vehicle interacting with a road and exchanging information with a remote server over a network;

FIG. 3 depicts a flow chart for an embodiment of a method of localizing a vehicle with a terrain-based localization system;

FIG. 4 depicts a process of terrain-based localization of a vehicle according to some exemplary embodiments;

FIG. 5 depicts a flow chart for another embodiment of a method of localizing a vehicle with a terrain-based localization system;

FIG. 6 is a flow chart for an embodiment of a method of localizing a vehicle with a terrain-based localization system; and

FIG. 7 depicts a flow chart for another embodiment of collecting a plurality of segments for terrain-based localization.

FIG. 8. illustrates an example where the position of a vehicle is shown at different time steps relative to a reference road surface profile.

FIG. 9 illustrates an example of where the precise position of the vehicle is known at each time step.

FIG. 10 illustrates an example of where the precise position of the vehicle is noy known at each time step.

FIG. 11 illustrates an example of where the correlation nodes are distributed uniformly in the range of uncertainty.

FIG. 12 illustrates an example showing the correlation values as a function of the position of the vehicle to the reference road-surface profile.

### DETAILED DESCRIPTION

A vehicle traveling along a road, autonomously or under the control of a driver, may interact with one or more road surface features that may expose the vehicle and/or one or more vehicle occupants to certain forces or accelerations. Such road features may affect the comfort and/or safety of vehicle occupants as well as wear-and-tear of the vehicle. The magnitude, direction, and/or frequency content of such forces or accelerations may be a function of the characteristics of one or more road surface features and the state of the vehicle. A typical road may include various types of road surface features, such as for example, road surface anomalies including, but not limited to potholes, bumps, surface cracks, expansion joints, frost heaves, rough patches, rumble strips, storm grates, etc.; and/or road surface properties, including but not limited to road surface texture, road surface composition, surface camber, surface slope, etc. Road surface properties may also affect road surface related parameters, such for example, the friction coefficient between the tires of a vehicle and the road surface, and traction and/or road-grip. Such parameters may determine how effectively certain maneuvers, such as turning and stopping, may be performed at various speeds and vehicle loading.

Various systems of a vehicle may be controlled based on the above-noted road surface properties and/or features. However, the types and characteristics of road surface features and/or properties may vary, for example, from road to road, as well as a function of longitudinal and/or lateral location on a given road. The effect of vehicle interactions, with a given road surface feature, on the vehicle and/or an occupant, may also vary as a function of vehicle speed at the time of the interaction between the vehicle and the road surface feature. The characteristics of a road surface feature may also vary, for example, based on weather conditions, and/or as a function of time. For example, if the road surface feature is a pothole, it may gradually appear and grow, in length, width, and/or depth, over the winter months as a result of repeated freeze/thaw cycles and then be repaired in a matter of hours or less and effectively disappear. Due to the changing nature, and/or previously unmapped layout, of a road surface, vehicles may sense the interactions of a vehicle with the road surface and then operate the various automatic and/or semi-automatic systems of the vehicle in response to the sensed interactions.

Properties and features of a road surface may be characterized and mapped to provide forward-looking or preview information about the road surface features located along a path of travel of a vehicle. This information about the road surface features and surface properties ahead of the vehicle may be used to, for example, dynamically tune, prepare, and/or control various automated or partially automated systems in the vehicle (such as for example, suspension systems (e.g., semi or fully active), propulsion systems, adaptive driver assistance systems (ADAS), electric power steering systems (EPS), antilock braking systems (ABS), etc.). When there is a physical interaction between a vehicle and a road surface feature, the vehicle may be exposed to one or more perceptible forces that are induced during the interaction. Thus, with a preview of the road ahead, e.g., receiving a priori road surface information, a vehicle controller may prepare to react to road surface features more effectively when there is a physical interaction between the road surface feature and the vehicle.

While information about a road surface may be useful for the control of various systems of a vehicle, the inventors have recognized that there are challenges to obtaining and using such road surface information. One such challenge is knowing with sufficient accuracy and resolution the location of the vehicle relative to various road surface features or sections of a road with certain surface characteristics, e.g. friction coefficient, so that the information regarding road features or characteristic ahead of the vehicle may be used to more effectively control various vehicle systems. For example, if the location of the vehicle is not known to a sufficient degree of accuracy, a vehicle controller may take an action that does not effectively mitigate the effects of a physical interaction of a vehicle with, for example, a road surface feature. As another example, if the location of the vehicle is not known to a sufficient degree of accuracy, a vehicle controller may not be able to respond appropriately and/or in a timely manner to, for example, mitigate or eliminate the effect of a physical interaction between the vehicle and the road feature leading to occupant discomfort or reduced safety. For example, a typical accuracy on Global Navigation Satellite Systems (GNSS) based location coordinates may be on the order of about 7 m to 30 m. With such lack of precision, a system controller in a vehicle may be unable to react effectively or in a timely manner to the interaction with a particular road surface feature (e.g., a pothole) or to determine if the interaction will occur.

Inventors have recognized that localization systems and methods incorporating terrain-based localization may offer better resolution and precision than conventional methods, e.g., GNSS and/or dead-reckoning based systems. When using a terrain-based localization system while traveling along a road, the road surface profile of the road may be determined by making certain measurements, with one or more sensors attached to the vehicle, e.g., by measuring the vertical motion of a portion of the vehicle (e.g., an unsprung mass). This currently measured road surface profile (i.e., measured during current travel) may then be compared with a previously determined reference road surface profile(s). Based at least in part on how well a portion of the currently measured road surface profile matches a portion of the reference profile, the current position of the vehicle may be determined more accurately than may be possible by other methods, e.g., by using GNSS. However, continuous pattern matching between a currently measured profile and a previously determined reference profile may require substantial data transmission and/or manipulation. That is, a single vehicle may need to stream sufficient road information such that the currently measured road surface profile may be continuously compared to the reference road surface profile while the vehicle is controlled based on its position and the information about the road surface ahead of it. The network bandwidth requirements may be substantial (and possibly be not feasible commercially) especially if the reference data is stored remotely and a plurality of vehicles are to be supported effectively simultaneously. Additionally, in some embodiments continuous pattern matching between a currently measured profile and a reference profile may require computing power beyond what may be commercially feasible to employ in a vehicle. If the computation is done remotely, such continuous pattern matching may further add to network bandwidth needs.

The Inventors have recognized that methods described herein may be used to reduce the computational and/or data communication burden(s) as compared to currently known continuous terrain-based localization techniques. These methods may instead be used to achieve high localization accuracy by relying on terrain-based localization to refine the estimated location of a vehicle as determined by less computationally/data intensive and less accurate localization techniques. For example, in some embodiments, other techniques such as GNSS and/or dead reckoning may be used until a vehicle is within a threshold distance of a known point on the road. Once within that threshold region (e.g., within the threshold distance from the known point), terrain-based localization may be implemented to determine a more precise location of the vehicle. In other embodiments, terrain-based localization in these regions (e.g., within a threshold distance of a known location) may include determining the vehicle location that produces a maximum correlation between a currently measured road-surface profile and a previously obtained reference road-surface profile.

In other alternative embodiments, and as discussed further below, the location of a vehicle may be refined by continuously or intermittently comparing a current road surface profile with multiple portions of a previously obtained reference road-surface profile.

In some embodiments of terrain-based localization systems, certain characteristics of a road segment (e.g., a continuous or effectively continuous road surface profile, discreet road surface features, or a combination of such characteristics), may be determined and stored in a database along with, e.g., metadata about the geographic coordinates, e.g., GNSS coordinates, of any appropriate, predetermined point of the road segment, e.g. mid-point or endpoint of the road segment. The predetermined length of the road segment may be any appropriate length, e.g., 20, 50, 80, 100, 500 meters. Road segments of other lengths, both longer and shorter that these are contemplated, as the present disclosure is not so limited. In some embodiments, the road segments in a network of one or more roads may be of equal length or of different lengths. In some embodiments, a road network may be established where the road segments are abutting so that the start-point of one segment coincides with the endpoint of the previous road segment such that there is no overlap. In some embodiments there may be some degree of overlap in at least some instances.

In some embodiments, while traveling along a given road segment (that may have a predetermined length λ) the road surface profile (i.e., current road surface profile) of a portion of the road (that the road segment is a part of), that has a length & and precedes (e.g., immediately proceeds) the current location of the vehicle, may be determined and retained. This current road surface profile, associated with the portion of length & that trails the vehicle's current position, may be determined based on data collected by one or more sensors on-board the vehicle during the current trip. In some embodiments, prior to reaching a predetermined point, of the given road segment (a point that has a known position (e.g., its GNSS coordinates are known)) previously stored road surface profile (i.e., reference road surface profile) of a portion the road segment of length δ that precedes the predetermined point, may be retrieved. As the vehicle approaches the predetermined point, as determined by using, e.g., a GNSS system or dead reckoning from a previous known position, the retrieved road surface profile (i.e., the reference road surface profile) of length δ, may be compared with the current road surface profile of the length δ, of road trailing the current position of the vehicle. In some embodiments, based on this comparison, it may be determined that the vehicle is currently at the predetermined point. In some embodiments length δ may be equal to length λ or substantially equal to length λ and the predetermined point may be the endpoint of the road segment. In some embodiments, this comparison may be achieved by determining the correlation between the current road surface profile and the reference road surface profile. However, by first using a less precise localization system (for example, GNSS or dead reckoning) to determine when a vehicle is approximately approaching a predetermined point of a road segment, e.g., the end of a road segment, and then using a terrain-based localization to more precisely determine when the vehicle is at the predetermined point, the data processing burden, of precisely determining the location of the vehicle, may be mitigated or reduced.

In some embodiments, given certain limitations, e.g., computational and/or bandwidth limitations, it may be advantageous to implement a terrain-based localization method occasionally or sparingly, e.g., when the vehicle is approaching a predetermined point in the road segment rather than continuously or effectively continuously. In such embodiments, the comparison between the current road surface profile data and the reference road surface profile may be performed only at predetermined intervals (e.g., time or distance intervals). For example, in some embodiments, terrain-based localization may be utilized as a vehicle approaches a predetermined point of a road segment, e.g., the endpoint of the road segment, but vehicle position may otherwise be determined by other means, for example, by dead reckoning or by the use of GNSS. Thus, in certain embodiments, between those occasions and/or road surface locations where terrain-based localization is used, dead-reckoning and or GNSS may be used to estimate the location of the vehicle (e.g., the position of the vehicle along a road) based on the previously identified location (e.g., the previously identified position along the road). For example, in certain embodiments, a terrain-based localization method may include first collecting, as a vehicle travels along a road, data from one or more sensors attached to the vehicle. The collected data may be processed (e.g., transformed from time to distance domain, filtered, etc.) to obtain current road surface profile data. The current road surface profile data may then be compared with reference road surface profile data associated with the road and, based at least in part on this comparison, the position of the vehicle along the road at a first point in time may be determined. Once the position of the vehicle along the road at the first point in time is determined, dead reckoning may be used to track the vehicle's position as it subsequently travels along the road. During the period of dead reckoning, new data from the one or more sensors may be collected and optionally processed to yield new current road surface profile data. In certain embodiments, upon determining that the vehicle has traveled a predetermined distance since the first point in time, the new current data may be compared with appropriate reference data. Based at least upon this second comparison, the position of the vehicle along the road at a second point in time may be determined. The process may then be repeated as the vehicle traverses sequentially located road segments, such that dead reckoning is used to track further movement of the vehicle, until it is determined that the vehicle has approximately traveled the predetermined distance since the second point in time the location was determined or that the vehicle is arrived at another predetermined point in the road. Upon this determination, terrain-based localization may be used to localize the vehicle at a third point in time. Thus, in some embodiments, comparisons may be carried out intermittently at predetermined distance intervals, which may be constant intervals, instead of continuously comparing current (e.g., the collected data and/or the processed data) data with reference data. Alternatively or additionally, terrain-based localization may be carried out upon determining that a predetermined time interval has passed since the first or previous point in time, rather than a predetermined distance interval. During these time/distance intervals, other less computationally intensive localization methods, e.g., dead reckoning, may be used to determine the position of the vehicle. Additionally, while the use of constant time and/or distance intervals are primarily disclosed herein, it should be understood that predetermined time and/or distance intervals used when determining a vehicle's location on different road segments may either be constant and/or variable between each other along different road segments as the disclosure is not limited in this fashion.

In some cases, employing a GNSS instead of dead reckoning may reduce error related to the distance determined during periods where there may be no reliance on road-surface localization. In some embodiments, GNSS may be used in combination with dead reckoning to further reduce error related to the predetermined distance, as the present disclosure is not so limited.

In some embodiments, in a road segment architecture, a given road may be segmented into a series of road segments of predetermined lengths that in some embodiments may be equal to each other, though embodiments in which road segments of unequal predetermined lengths are used are also contemplated. Each road segment may include one or more road surface profiles that may be employed for terrain-based localization as described herein.

The road surface profiles may be obtained by measuring, e.g., vertical motion of a portion of a vehicle (e.g., the unsprung mass, the wheel assembly, the sprung mass, the body of the vehicle) using one or more motion sensitive sensors (e.g., accelerometer(s), displacement sensor(s), IMU(s)) attached to one or more points of the vehicle as the vehicle traverses the road segment. The road segments of predetermined equal lengths or unequal lengths may be referred to as “slices”. In certain embodiments, consecutive road segments may be arranged in a contiguous fashion such that the endpoint of one road segment coincides or approximately coincides with the starting point of a subsequent road segment. In some embodiments, the consecutive road segments may be non-overlapping, such that an endpoint of one road segment coincides with a starting point of a subsequent road segment. Alternatively, in some embodiments, road segments may overlap, such that the start point of a subsequent road segment may be located within the boundaries of a previous road segment. Road segments may be, for example, any appropriate length, including, but not limited to, ranges between any combination of the following lengths: 20 meters, 40 meters, 50 meters, 60 meters, 80 meters, 100 meters, 120 meters, 200 meters or greater. In some embodiments, a road segment may have a length between 20 and 200 meters, 20 and 120 meters, 40 and 80 meters, 50 and 200 meters, and/or any other appropriate range of lengths. Other lengths that are longer or shorter than these lengths are also contemplated, as the present disclosure is not so limited. In certain embodiments, the length of the road segment into which a road is divided may depend on the type of road and/or the average speed travelled by vehicles on the road or other appropriate considerations. For example, on a single lane city road, vehicles may generally travel at relatively low rates of speed as compared to multilane highways. Therefore, on a city road (or other road with relatively low travel speeds) it may be advantageous or otherwise desirable to have relatively shorter road segments (e.g., between 20 and 60 meters) than on highways or other roads with relatively high travel speeds (e.g., between 80 and 120 meters), such that each road segment may correspond to an approximate average travel time from start to end of the road segment regardless of average travel speed on the road.

In some embodiments, a method of localizing a vehicle using road segments includes measuring a current road surface profile by using one or more sensors in a vehicle. The method may also include determining that the vehicle is within a threshold distance from a position or point on a road segment, e.g., from the segment endpoint. For example, in some embodiments, determining the vehicle is within a threshold distance of a road segment endpoint includes estimating a location of the vehicle with a GNSS, dead reckoning from a last known vehicle location, and/or any other appropriate localization method. The method may also include comparing a reference road surface profile corresponding to the road segment along a vehicle's path of travel to the current road surface profile determined, at least partially, by systems on board the vehicle during a current traverse of the road segment. In some embodiments, the measured current road surface profile may be compared to the reference road surface profile as the vehicle traverses the road segment, where the current road surface profile and reference road surface profile have approximately equal (e.g., equal) lengths. The method may include determining a correlation between the current road surface profile and the reference road surface profile, for example, using a cross-correlation function or another appropriate function that assesses similarity between the current road surface profile and the reference road surface profile (e.g., dynamic time warping, etc.). The method may also include determining if the correlation between the current road surface profile and the reference road surface profile exceeds a threshold correlation. The threshold correlation may be predetermined based at least in part on a road type, as will be discussed in detail further below. If the correlation exceeds the threshold correlation, the location of the vehicle may be determined to be, e.g., the segment endpoint. If the correlation does not exceed the threshold correlation, the location of the vehicle may be not yet determined, and the method may continue while the vehicle advances down the road and collecting additional current data. With the current road surface profile augmented in this manner, the correlation between the current road surface profile (including additional data measured while advancing down the road) and the reference road surface profile may be recomputed. When the current data set is augmented in this way, an appropriate amount to data at the beginning of the data set may be dropped so that the length of road associated with the current road surface profile and the length of road associated with the reference road surface profile are equal or effectively equal.

It is noted that, as the vehicle approaches the predetermined point in the road, e.g., the endpoint, the correlation between the current road surface profile and the reference road surface profile may increase to a peak as a function of vehicle position. Accordingly, in some embodiments, the method may include detecting a peak in the correlation between the current road surface profile and the reference road surface profile, determined at multiple locations of the vehicle or continuously, as the vehicle moves through an area within a threshold distance of a predetermined position of the road segment, e.g. the segment endpoint. Additional details of such peak detection are discussed in further detail below.

The various embodiments disclosed herein are related to determining the location of a vehicle on a road surface and/or for creating maps of road segments including information that may be used to locate the position of a vehicle along a road surface. Based on such information, the relative position of the vehicle relative to one or more road surface features and/or road surface regions may be determined.

As noted previously, access to such a priori information about a portion of a road segment may enable the effective control of one or more systems in a vehicle, e.g., automatic and/or semi-automatic systems of the vehicle. Accordingly, any of the embodiments disclosed herein may also provide information, e.g., vehicle, road surface feature characterization and/or location, and/or location specific road surface parameters, e.g., friction coefficient, that may be used by one or more vehicles to control one or more vehicle systems. Thus, in some embodiments, one or more systems of a vehicle may be controlled based at least in part on a determined location of a vehicle, dead reckoning, and information about one or more characteristics of the road segment (e.g., profile of a road segment, and friction coefficient. Examples of systems that may be controlled, based on a priori road surface information, may include suspension systems (semi or fully active), propulsion system, advanced driver assistance systems (ADAS), electric power steering (EPS), antilock braking systems (ABS), autonomous vehicle controller, and/or any other appropriate type of vehicle system.

A vehicle controller may include one or more microprocessors. The one or more processors may be configured to execute computer readable instructions stored in volatile or non-volatile computer readable memory that when executed perform any of the methods disclosed herein. The one or more processors may communicate with one or more actuators associated with various systems of the vehicle (e.g., braking system, active or semi-active suspension system, driver assistance system, etc.) to control activation, movement, or other operating parameter of the various systems of the vehicle. The one or more processors may receive information from one or more sensors that provide feedback regarding the various portions of the vehicle. For example, the one or more processors may receive location information regarding the vehicle from a Global Navigation Satellite System (GNSS) such as a global positioning system or other positioning system. The sensors on board the vehicle may include, but are not limited to, wheel rotation speed sensors, inertial measurement units (IMUs), optical sensors (e.g., cameras, LIDAR), radar, suspension position sensors, gyroscopes, etc. In this manner, the vehicle control system may implement proportional control, integral control, derivative control, a combination thereof (e.g., PID control), or other control strategies of various systems of the vehicle. Other feedback or feedforward control schemes are also contemplated, and the present disclosure is not limited in this regard. Any suitable sensors in any desirable quantities may be employed to provide feedback information to the one or more processors. It should be noted that while exemplary embodiments described herein may be described with reference to a single processor, any suitable number of processors may be employed as a part of a vehicle, as the present disclosure is not so limited.

According to exemplary embodiments described herein, one or more processors of a vehicle may also communicate with other controllers, computers, and/or processors on a local area network, wide area network, or internet using an appropriate wireless or wired communication protocol. For example, one or more processors of a vehicle may communicate wirelessly using any suitable protocol, including, but not limited to, WiFi, GSM, GPRS, EDGE, HSPA, CDMA, and UMTS. Of course, any suitable communication protocol may be employed, as the present disclosure is not so limited. For example, the one or more processors may communicate with one or more servers from which the one or more processors may access road segment information. In some embodiments, one or more servers may include one more server processors configured to communicate in two-way communication with one or more vehicles. The one or more servers may be configured to receive road surface profile information from the one or more vehicles, and store and/or utilize that road surface profile information to form road segment information. The one or more servers may also be configured to send reference road surface profile information to one or more vehicles, such that a vehicle may employ terrain-based localization according to exemplary embodiments described herein, and one or more vehicle systems may be controlled or one or more parameters of the one and/or more vehicle systems may be adjusted based on forward looking road surface profile information.

In the various embodiments described herein, in some instances, a method of terrain-based localization may be based on peak detection of a cross-correlation between a reference road surface profile and a current road surface profile as a vehicle passes through a point in the road segment, e.g. the segment endpoint. In some embodiments, a current road surface profile of a predetermined length approximately equivalent to that of the reference road surface profile may be cross correlated with the appropriate reference road surface profile once the vehicle enters a threshold range of a predetermined point in the road, e.g., the road segment endpoint, to obtain a correlation value, of e.g., between 0 and 1. In some embodiments, the threshold range of the predetermined point, e.g., road segment endpoint may be less than 15 m, 10 m, 5 m, and/or any other appropriate range. In some embodiments, the threshold range of the road segment endpoint may be based at least partly on a resolution of a GNSS onboard the vehicle. In such embodiments, the threshold range may be approximately equal (e.g., equal) to the resolution of the GNSS.

According to some exemplary embodiments described herein, once a vehicle enters the threshold range of a predetermined point in the road, e.g., the road segment endpoint, a cross correlation between the current road surface profile and reference road surface profile may be performed and the correlation value or magnitude determined. If the correlation does not exceed a threshold correlation value or magnitude, the vehicle location may be undetermined, and the process of terrain-based localization may be repeated as the vehicle continues to travel down the road. While the vehicle may be within the threshold range of a predetermined point in the road segment, e.g., the road segment endpoint, a correlation may be determined again. The correlation may be determined multiple times, or repeatedly, or effectively continuously (e.g., at each time step). The current road surface profile may be modified to incorporate the most recent data from the vehicle and to drop the oldest data falling outside of a predetermined length. In some embodiments the predetermined length may be equal or shorter than the length of the current segment. Each time a correlation is determined, it may be determined if the correlation exceeds the threshold correlation. Once the correlation exceeds the threshold correlation at a given time step, it may be determined that the vehicle may be located at the road segment endpoint, or other predetermined position on road segment, at that time step. In some embodiments, a peak detection algorithm may be applied to determine if the correlation between the current road surface profile and reference road surface profile is a maximum correlation. In some such embodiments, a slope of the correlation may be determined between the most recent time step and earlier time steps. In some embodiments, a peak may be determined where the slope is negative, and the correlation is decreasing after the correlation exceeded the threshold correlation. Of course, any suitable peak detection function may be applied, as the present disclosure is not so limited. In some embodiments, a threshold correlation may be greater than or equal to 0.6, 0.7, 0.8, 0.9, and/or any other appropriate value. In some embodiments, the threshold correlation may be based at least partly on the type of road segment. For example, a highway or high-speed road may have a greater threshold correlation than a low-speed road where more variations in a path taken by a vehicle may be present. According to this example, in some embodiments, a threshold correlation for a highway may be greater than or equal to 0.8, and a threshold correlation for a non-highway road may be greater than or equal to 0.5.

According to exemplary embodiments described herein, road segment information may be stored in one or more databases onboard a vehicle and/or in one or more remotely located servers and/or databases. In some embodiments, a database may be contained in non-transitory computer readable memory. In certain embodiments, the database may be stored in memory that is exclusively or partially located remotely (e.g., “in the cloud”) from the vehicle, and the database and the vehicle may exchange information via a wireless network (e.g., a cellular network (e.g., 5G, 4G), WiFi, etc.). Alternatively, in some embodiments, the database may be stored in non-transitory memory that is located on the vehicle. In certain embodiments. Road segments may be specific for a direction of travel, such that for “two-way” roads (i.e., roads which support simultaneous travel in opposing directions), there may be a distinct set of road segments for each direction of travel (e.g., a first set of road segments for travel in a first direction and a second set of distinct road segments for travel in a second direction).

As used herein, the term “road surface profile” refers to any appropriate description or characterization of a road surface as a function of distance. For example, a road surface profile may refer to a road height profile that describes variations of height of a road's surface as a function of distance along a given road segment. Alternatively or additionally, a road surface profile may refer to mathematically related descriptions of road surface. For example, a road surface profile may refer to a “road slope” profile that describes road slope as a function of distance along a road segment. A road surface profile of a road segment may be obtained, for example, by measuring, as a vehicle traverses the road segment, vertical motion (e.g., acceleration data, velocity data, position data or displacement) of a portion of the vehicle (e.g., to the vehicle's wheel, wheel assembly, or other part of the unsprung mass; or a portion of the vehicle's sprung mass), and optionally processing this data (e.g., transforming it from time to distance domains based on operating speed, integrating the data with respect to time, filtering it (e.g., to remove wheel hop effects, etc.). For example, if vertical acceleration of a wheel is measured using an accelerometer attached to the wheel, then vertical velocity of the wheel may be obtained through integration of the acceleration signal, and vertical height obtained through further integration. With knowledge of the operating speed of the vehicle (that is, the speed at which the vehicle traverses the road segment, e.g., in the forward direction), vertical height with respect to distance travelled may be obtained. In some embodiments, further filtering may be advantageous. In one example, a road height profile may be obtained from the wheel's vertical height data (e.g., as determined by measuring acceleration of the wheel) by applying a notch filter or low-pass filter (to, e.g., measured vertical acceleration of the wheel) to remove effects of wheel hop and/or low frequency content. A road surface profile may incorporate information describing or characterizing discrete road surface anomalies such as, for example, potholes (or other “negative” events) and/or bumps (or other “positive” events). Additionally or alternatively, a road surface profile may incorporate information about distributed road surface characteristics such as road roughness and/or road surface friction.

According to exemplary embodiments described herein, if a vehicle travels on a road (or section of a road) for which no reference road surface profile data is available, reference data (including, e.g., a reference road surface profile, characterization of the road's surface, and/or the presence of irregular events such as bumps or portholes) may be generated by collecting motion data from one or more motion sensors (e.g., accelerometers, position sensors, etc.) attached to one or more points of the vehicle (e.g., attached to a wheel of the vehicle, a wheel assembly of the vehicle, a damper, another part of the unsprung mass of the vehicle, or a part of the sprung mass of the vehicle). Data collected from a road or road section, where usable reference data may be unavailable, may be used to generate the reference data that may then be stored in a database and associated with the particular road segment of the road or road section. Alternatively, data may be collected from a plurality of vehicle traversals and merged (e.g., averaged using a mean, mode, and/or median of the reference data) together to generate reference data.

According to exemplary embodiments described herein, the location of a vehicle may be estimated or at least partially determined by, for example, absolute localization systems such as satellite-based systems. Such systems may be used to provide, for example, an estimate of the absolute geocoordinates (i.e., geographic coordinates on the surface of the earth such as longitude, latitude, and/or altitude) of a vehicle. Satellite based systems, generally referred to as a Global Navigation Satellite System (GNSS), may include a satellite constellation that provides positioning, navigation, and timing (PNT) services on a global or regional basis. While the US based GPS is the most prevalent GNSS, other nations are fielding, or have fielded, their own systems to provide complementary or independent PNT capability. These include, for example: BeiDou/BDS (China), Galileo (Europe), GLONASS (Russia), IRNSS/NavIC (India) and QZSS (Japan). Systems and methods according to exemplary embodiments described herein may employ any suitable GNSS, as the present disclosure is not so limited.

According to exemplary embodiments described herein, dead reckoning may either be used to update the location of the vehicle at a time point after the vehicle's previously ascertained location using the vehicle's measured path of travel and/or displacement from the previously ascertained location. For example, the distance and direction of travel may be used to determine a path of travel from the known location of the vehicle to determine a current, updated location of the vehicle. Appropriate inputs that may be used to determine a change in location of the vehicle after the previously ascertained location of the vehicle may include, but are not limited to, inertial measurement units (IMUs), accelerometers, steering system sensors, wheel angle sensors, wheel speed sensors, relative offsets in measured GNSS locations between different time points, and/or any other appropriate sensors and/or inputs that may be used to determine the relative movement of a vehicle on the road surface relative to a previous known location of the vehicle. This general description of dead reckoning may be used with any of the embodiments described herein to determine a location of the vehicle for use with the methods and/or systems disclosed herein.

In some cases, roads may include more than one track (e.g., lane of travel whether physically marked (e.g., with lane markers) or unmarked) for each direction of travel, and each track or lane may have a different road surface profile may differ for each track. It may not be known in a reference database how many tracks (e.g., lanes) are in a road or road segment, which may lead to difficulties when generating reference data for the road or road section. For example, if a reference road surface profile for a given road is based on data generated by one or more vehicles travelling in the left-most track or lane of a multi-lane road, subsequent attempts to use that reference road surface profile to localize (e.g., determine the position of) a vehicle travelling in the right-most track or lane may fail due to differences in road surface between the left-most track or lane and the right-most track or lane. Thus, knowing both how many tracks or lanes a road has, and in which track a vehicle is travelling, may be desirable for both generating reference road surface profiles, subsequent localization, and for using the information for controlling a vehicle and/or one or more vehicle systems. Prior attempts at determining a track of a road surface profile have raised computational challenges, such as data storage for road surface profiles of multi-lane use (e.g., a lane change) which may not be useful for traversals of a road segment which may occur in a single lane.

In some embodiments, there may be a benefit to having a road segment organizational structure in which multiple road surface profiles may be associated with a single road segment. The road segment structure allows multiple road surface profiles to be associated with a road segment in a manner that may be less data and computationally intensive.

In some embodiments, a method of identifying a track (or lane) profile of a road segment includes measuring a road surface profile of the road segment with any appropriate onboard sensor(s) as disclosed herein as the vehicle traverses the road segment (e.g., employing a vehicle according to exemplary embodiments described herein). A current road surface profile of a road or road segment may be transmitted to a server when a vehicle traverses the road segment, such that a plurality of vehicles may transmit a plurality of measured road surface profiles of, for example, tracks or lanes of a road to the server. The method may also include determining if the number of stored road surface profiles exceed a threshold number of road surface profiles. The threshold number of road surface profiles may be predetermined to allow a sufficient number of road surface profiles to be collected prior to data manipulation. In some cases, the threshold number of road surface profiles may be based on the type of road segment. For example, a high-speed road such as a highway may have a greater threshold number of road surface profiles as highways typically include more lanes than low speed roads. In some embodiments, the threshold number of road surface profiles may be between 2 and 64 road surface profiles, between 8 and 12 road surface profiles, and/or any other suitable number. If the server or data center receives a road surface profile from the vehicle and the threshold number of stored road surface profiles is not exceeded, the received measured road surface profile may be stored and associated with the road segment. However, if the threshold number of road surface profiles is reached or exceeded by the received measured road surface profile, the method may include identifying the most similar two road surface profiles of the measured road surface profile and stored road surface profiles. The most similar two road surface profiles may be identified based on a cross-correlation function performed on each pair of road surface profiles and comparing the resulting degree of similarity values. If the degree of similarity of the two most similar road surface profiles exceed a predetermined similarity threshold, the two most similar road surface profiles may be merged into a merged road surface profile. If the degree of similarity of the two most similar profiles does not exceed a similarity threshold, the oldest road surface profile may be discarded, and the newly measured road surface profile stored. In this manner, similar road surface profiles may be retained by the server, whereas outlier road surface profiles may be eventually dropped. As similar road surface profiles are merged, information regarding how many road surface profiles have been merged into a single merged profile may be kept as metadata, with greater numbers of road surface profiles in a single merged profile representing a track (e.g., lane) of a road segment.

In some embodiments, a degree of similarity may be a value between 0 and 1 which is the output of a cross-correlation function. In some embodiments, a similarity threshold for merging road surface profiles may be greater than or equal to 0.6, 0.7, 0.8, 0.9, and/or any other appropriate value. In some embodiments, the similarity threshold may be based at least partly on the type of road segment. For example, a highway or high-speed road may have a greater threshold correlation than a low-speed road where more variations in a path taken by a vehicle may be present. According to this example, in some embodiments, a threshold correlation for a highway may be greater than or equal to 0.8, and threshold correlation for a non-highway road may be greater than or equal to 0.5.

In some embodiments, if a set of road surface profiles includes a sufficiently large number of road surface profiles (e.g., exceeding a threshold number of road surface profiles), a correlation clustering algorithm may be used on the set of road surface profiles. A number of appropriate correlation clustering algorithms are known in the art, including, for example, hierarchal or partitional clustering methods (e.g., k-means clustering, c-means clustering, principal component analysis, hierarchal agglomerative clustering, divisive clustering, Bayesian clustering, spectral clustering, density-based clustering, etc.) Subsequent to a correlation clustering process, the set of road surface profiles may be grouped into one or more clusters, where each road surface profile contained within a given cluster is substantially similar to each other road surface profile contained within the given cluster. For example, the set of road surface profiles in a road segment may be divided into at least a first cluster of road surface profiles and a second cluster of road surface profiles, where each road surface profile in the first cluster is substantially similar to each other road surface profile in the first cluster, and each road surface profile in the second cluster is substantially similar to each other road surface profile in the second cluster. In some embodiments, a similarity of the plurality of road surface profiles in each cluster may be more similar to other road surface profiles in the same road cluster as compared to road surface profiles in other clusters as determined using any appropriate comparison method including, for example, a cross correlation function as described herein. In certain embodiments, each cluster may be considered as corresponding to a track (or a lane) of the road, or road segment which may be marked (e.g. with lane markers) or unmarked. In certain embodiments, all of the road surface profiles within a given cluster may be merged (e.g., averaged), in order to obtain a single-track merged road surface profile. Such a merged road surface profile may serve as the reference road surface profile for a given track within a road segment (e.g., for future terrain-based localization or future preview control of vehicles (e.g., controlling one or more vehicular systems based on knowledge of upcoming road characteristics)), and may be stored in an appropriate database and associated with a specific track in a road segment. This merging may be carried out for each identified cluster. In certain embodiments, the clustering algorithm may be periodically repeated (e.g., after a certain number of new road surface profiles are collected for a given road segment). Alternatively, the clustering algorithm may be repeated after each new road surface profile is collected to determine which cluster the new profile belongs in.

In some embodiments, rather than considering each cluster to correspond to a track, only clusters having a number of road surface profiles that exceed a threshold number of road surface profiles may be considered to correspond to tracks. A track represents a path that vehicles take when traversing a road segment. For example, a cluster that includes a single road surface profile or a small number of profiles less than a threshold number of road surface profiles, may be considered an outlier, rather than a separate track. Outliers may occur, for example, when a vehicle experiences an atypical event while traversing a road segment (e.g., the vehicle may change lanes within a road segment, or may traverse some temporary debris or garbage on the road that is not typically present). In certain embodiments, road surface profiles considered outliers may be deleted after a predetermined period of time has passed in order to conserve memory or storage space, not cause confusion, or other appropriate reasons.

According to exemplary embodiments described herein, one or more road surface profiles may be merged into a merged road surface profile. In some embodiments, merging two or more road surface profiles may include averaging the two or more profiles. In some embodiments, merging the two or more road surface profiles may include accounting for the range of frequencies over which the information provided in a measured road surface profile is valid or sufficiently accurate. In some instances, two or more measured road surface profiles may have an acceptable degree of accuracy in over lapping, but not identical, frequency ranges. In such instances, the overlapping portions may be averaged while the non-overlapping portions the data with the acceptable degree of accuracy may be used. A reference profile created from multiple overlapping, but not identical, measured road surface profiles may have a wider frequency range than an individual measured road surface profile. According to such an embodiment, sensors of varying quality and operating frequency range may be merged into a merged profile without distorting the merged road surface profile, as the most useable data from each measure profile may be combined.

Any suitable technique for merging two or more road surface profiles may be employed, as the present disclosure is not so limited.

In some embodiments, tracks associated with consecutive or abutting road segments may be linked in a database. These links may form a directed graph showing how tracks on consecutive road segments are visited. For example, a given road may include a first road segment and a second road segment, where the first road segment and second road segment are consecutive or abutting road segments or road slices. If it is determined that the first road segment contains two tracks (which, in some embodiments, may correspond to physically marked lanes on a roadway) and the second road segment contains two tracks, each track of the first road segment may be linked in the database to a respective track in the second road segment. This “track linking” may be carried out based on historical information—for example, if it is observed that a majority of vehicles, or other appropriate threshold, travel from one track (with a first reference road surface profile) in a first road segment to a corresponding track (with a second reference road surface profile) in the second road segment those tracks may be linked together in a database containing the road surface profiles of the various road segments. For example, if vehicles preferably travel from “track 1” in the first road segment to “track 1” in the second road segment, then track 1 of the first road segment may be linked to track 1 in the second road segment. These linkages may be used to predict travel, such that if a vehicle at a given time is localized to “track 1” in the first road segment, it may be assumed, for example, that the vehicle is likely to continue to “track 1” in the second road segment. Accordingly, a vehicle may use a track identification to prepare and/or control one or more vehicle systems for an upcoming road surface profile in a subsequent road segment or slice.

In some embodiments, a road surface profile may include additional information regarding the vehicle traversal to assist with clustering and/or lane identification according to exemplary embodiments described herein. For example, in some embodiments, a road surface profile may include an average speed which may be determined by averaging the speeds of vehicles traversing the road segment when measuring the various measured profiles used to determine the road surface profile. According to such an example, the average speed may assist in lane identification and clustering, as lanes may differ in average speed. For example, in the U.S., a right-most lane may have the lowest average speed whereas the left-most land may have the highest average speed. Accordingly, a first track with a lower or lowest average speed may be associated with a right-most lane and a second track with a higher or highest average speed may be associated with a left-most lane of a roadway. Of course, any suitable information may be collected and employed to identify a vehicle lane of a road segment, including for example optical data or sub-surface data, as the present disclosure is not so limited.

The “location” or “position” of a vehicle may be expressed in absolute coordinates, or it may refer to a location of a vehicle relative to a road or road segment. For example, the location or position of a vehicle may also be expressed as a distance relative to a feature of a road (e.g., as a distance relative to the start of a road, relative to an intersection, relative to a feature located on the road, e.g., a pothole, an artificial marker, etc.).

It should be understood that, while specific types of sensors for measuring a road surface profile may be described in the embodiments below, any appropriate type of sensor capable of directly measuring height variations in the road surface, or measuring other parameters related to height variations of the road surface from which height variations may be deduced (e.g., accelerations of one or more portions of a vehicle, such as the sprung mass or an unsprung mass of a vehicle, as it traverses a road surface), or any other road surface characteristics (e.g., friction coefficient) may be used, as the disclosure is not so limited. For example, inertial measurement units (e.g., (IMUs), accelerometers, displacement sensors), optical sensors (e.g., cameras, LIDAR), radar, suspension position sensors, gyroscopes, and/or any other appropriate type of sensor may be used in the various embodiments disclosed herein to measure a road surface profile of a road segment a vehicle is traversing, as the disclosure is not limited in this fashion.

As used herein, the term “an average” may refer to the result of any appropriate type of averaging used with any of the parameters, road surface profiles, or other road characteristics associated with the various embodiments described herein. This may include averages such as a mean, mode, and/or median. However, it should be understood that any appropriate combination of normalization, smoothing, filtering, interpolation, and/or any other appropriate type of data manipulation may be applied to the data to be averaged prior to averaging as the disclosure is not limited in this fashion.

As used herein, a “road surface profile” or “road surface characteristics” may correspond to a “track” or a “lane”, which in some instances these two terms may be used interchangeably. As used herein, a “track” may be a path that one or more vehicles take to traverse the length of a road segment. In some embodiments, “clusters” correspond to “tracks” and/or “lanes” where two or more measured road surface profiles have been averaged. In some embodiments, “tracks” correspond to physically marked “lanes” on a road. In other embodiments, “tracks” may not necessarily correspond to physically marked “lanes” on a road.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

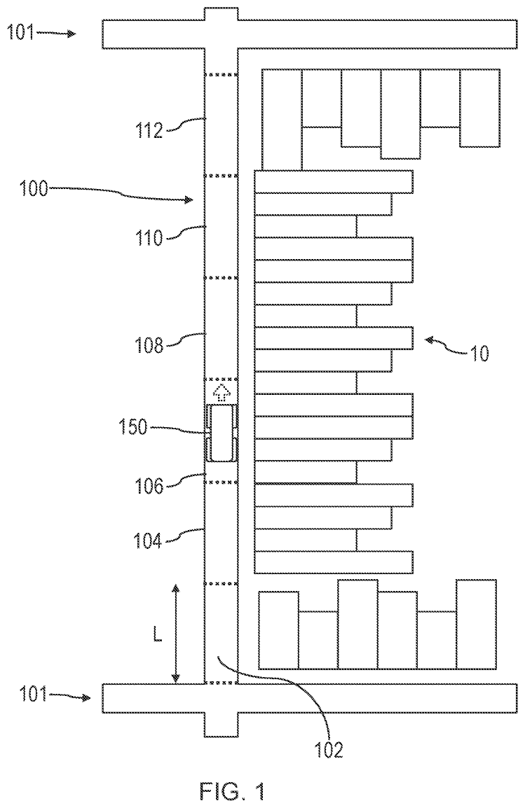

FIG. 1 depicts an embodiment of a road map including a road 100 divided into a set of road segments. As shown in FIG. 1, the road map includes the road 100 and cross-roads 101 which intersect with the road 100 at one or more locations along the length of the road. For the sake of simplicity, the intersecting roads are not shown as divided into road segments. Additionally, for illustration a plurality of buildings 10 are represented by rectangles on the road map. As shown in FIG. 1, a vehicle 150 is traveling on the road 100. The road 100 is broken into six road segments in the embodiment of FIG. 1: a first road segment 102, a second road segment 104, a third road segment 106, a fourth road segment 108, a fifth road segment 110, and a sixth road segment 112. In this illustrative example, each road segment 102, 104, 106, 108, 110, 112 has a common length “L”, and is associated at least with a start point and an endpoint. However, segments may also be used that have unequal lengths and/or segments that include a beginning portion that overlaps a portion at the end of the previous segment. The start and endpoints shown in FIG. 1 are illustrated as dashed lines, though in some embodiments the start and endpoints may be single points defined by geographical coordinates. In some embodiments, as shown in FIG. 1, the start-point of a given road segment may coincide with the endpoint of a previous abutting road segment. In some embodiments, the length of each road segment may be between 60 m and 100 m, though the disclosure is not so limited and road segments of other lengths may be used as discussed herein. Exemplarily methods employing the road segments of FIG. 1 will be discussed further below.

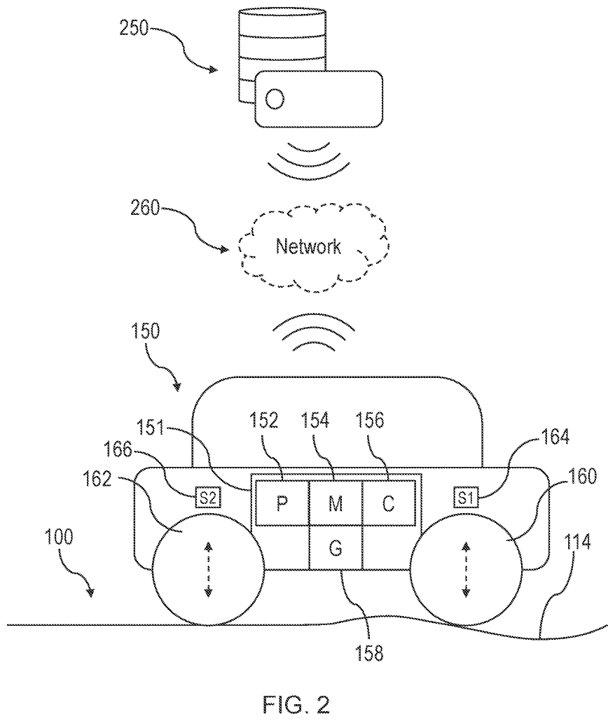

FIG. 2 depicts a schematic of an embodiment of a vehicle 150. The vehicle 150 may be employed in various methods according to exemplary embodiments described herein. As shown in FIG. 2, the vehicle includes a vehicle control system 151 which is configured to control one or more systems of the vehicle. In some embodiments as shown in FIG. 2, the vehicle control system includes one or more processors 152, non-transitory computer readable memory 154 associated with the one or more processors, and a communications module 156. The processor may be configured to execute computer readable instructions which may be stored in the non-transitory computer readable memory to perform various methods described herein, and to control various systems of the vehicle. The communications module 156 may be a wireless communications module configured to allow the vehicle control system to communicate with remote devices (e.g., other vehicles, a server, the internet, etc.). The communications module 156 may employ any suitable wireless communication protocol. In some embodiments, the communications module 156 may be configured for one or two-way communication with a remote device such that the communications module may send and/or receive information. According to some embodiments as shown in FIG. 2, the vehicle 150 may include a Global Navigation Satellite System receiver (GNSS receiver) 158 which may be employed to estimate a location of the vehicle, which may in turn be supplemented by using terrain-based localization methods implemented by a terrain-based localization system as described herein. According to the embodiment of FIG. 2, the vehicle 150 includes wheels 160, 162 which traverse a road 100 having road features 114. The vehicle 150 includes one or more sensors associated with one or more portions of the vehicle, such as the depicted first sensor 164 and/or second sensor 166 configured to measure displacement of the wheels to measure the road surface profile of the road 100. For example, the first sensor 164 and second sensor 166 may be accelerometers configured to measure movement of, for example, the vehicle body or the wheel assembly. However, different types of sensors associated with different portions of the vehicle may be used to measure a road surface profile as previously described. Regardless of the specific sensor(s) used, the measured information from the sensor(s) may be transmitted to the processors 152, which may aggregate the sensor signals to form a measured road surface profile.

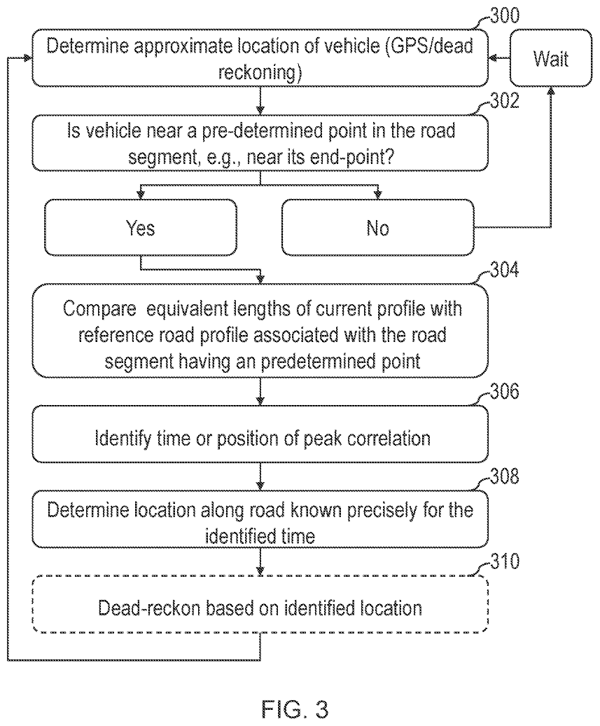

According to the embodiment of FIG. 2, the vehicle 150 is configured to communicate with one or more remote servers, other vehicles, and/or any other appropriate system via communications module 156. In some embodiments as shown in FIG. 2, the communications module 156 may communicate via a network 260 (e.g., a local area network, wide area network, internet, etc.) to a server 250. The communications module may send information (e.g., measured road surface profile information) to the server 250, and the communications module may receive information (e.g., reference road surface profile information, road segment information) from the server. The organizational structure of road segment information received from the server 250 is discussed further with reference to FIG. 3. While in the embodiment of FIG. 2 the vehicle is communicating with a single server, a vehicle may communicate with any number of servers or other remote devices, e.g. microprocessors, as the present disclosure is not so limited. In some embodiments, the server may include a database of road segment information for a road network.

FIG. 3 depicts a flow chart for an embodiment of a method of localizing a vehicle with a terrain-based localization system utilizing a road segment architecture. In some embodiments, as the vehicle travels along a road, a current road surface profile may be continually obtained (e.g., using one or more on-board sensors such as accelerometers). Further, a controller controlling one or more systems in the vehicle may be in communication with a database (e.g., on a remote or local server) that stores previously measured and/or processed information about a series of road segments. This information may include, e.g., (i) an endpoint location of one or more road segment of the series (e.g., as illustrated in FIG. 3), and (ii) at least one reference road surface profile associated with those one or more road segments. Alternatively or additionally, this information may include, e.g., (i) the location of a predetermined point in one or more road segments of the series (not shown in FIG. 3), and (ii) at least one reference road surface profile of at least a portion associated with the one or more road segments.

In block 300 of the illustrative example of FIG. 3, an approximate location of the vehicle may be determined using a first localization system having a first resolution. In certain embodiments, this approximate location may be determined using a vehicle's reported GNSS (e.g., GPS) coordinates, in which case the location is accurate to within resolution of the GNSS employed. Alternatively or additionally, this approximate location may be determined using dead reckoning relative to a previously known position of the vehicle (e.g., using vehicle speed, direction, and/or acceleration or velocity integration). In block 302, the vehicle's approximate position may be compared with the relative position of a pre-determined point of one or more road segments of a road, where the predetermined point may be an endpoint of a road segment. If it is determined that the vehicle is near a previously selected point of any road segment (e.g., within a threshold distance of the predetermined point), the corresponding road segment (that is, the current road segment on which the vehicle is located) may be selected for comparison. In some embodiments, a vehicle may be considered near a predetermined point in a segment (e.g., the endpoint, mid-point, or other appropriate point) of the segment, if the vehicle's approximate location is within a threshold distance from that predetermined point of a road segment. For example, in some embodiments the threshold distance may be 0.05 L, 0.1 L, 0.2 L, 0.4 L, or 0.5 L where “L” is the length of the road segment. Other ranges of threshold distances that are longer or shorter may be utilized, including thresholds provided in terms of absolute lengths as described herein, as the disclosure is not so limited. If it is determined that the vehicle is not within a predetermined distance from a predetermined point (e.g. an endpoint, mid-point, or other appropriate point) of the segment, of any road segment, then the system may return to the step 300 and re-approximate the vehicle's location during a subsequent or next time step. In some embodiments, a vehicle may re-approximate its position effectively continuously (e.g., each predetermined time step). Alternatively, in some embodiments, the position of the vehicle may be reapproximated following a predetermined interval (e.g., a predetermined time and/or distance interval).

As shown in the embodiment illustrated in FIG. 3, in block 304, after a vehicle is determined to be within a predetermined distance, or other threshold, of an endpoint or other predetermined point of the road segment, the process may include continuously or on multiple occasions comparing the current road surface profile with a reference road surface profile of the road segment of the same length or equivalent length as the current road surface profile. In some embodiments, where the predetermined point is an endpoint, this comparison (e.g., cross correlation) may be performed with a portion of the road segment which is “L” meters long. In some embodiments, the current road surface profile may continuously on multiple occasions be compared to the reference road surface profile while the vehicle is near (e.g. within a predetermined threshold distance), for example, the road segment endpoint or other pre-determined point at certain temporal intervals (e.g., once every 0.01 seconds, once every 0.1 seconds, once every 0.2 seconds) and/or distance intervals (e.g., 0.05 L, 0.1 L, 0.2 L, 0.3 L, etc.). Other temporal or distance intervals that are shorter or longer may be employed, as the present disclosure is not so limited. The length of road for which the comparison is performed may be an appropriate length, e.g. equal to L or the length of the entire road segment or slice or equal in length to a portion of the road segment.

In some embodiments, the comparison between equivalent lengths of the current road surface profile and the reference road surface profile may be performed at various positions as the vehicle approaches a predetermined point of the road, e.g., the road segment endpoint, by using a cross-correlation function, which may output a correlation value. In block 306, the time and/or position of maximum correlation between the current road surface profile and the reference road surface profile, as the vehicle approaches the predetermined point, e.g., segment endpoint, may be determined (e.g., using peak detection). In block 308, once the time or position of maximum correlation is determined, it may be assumed that the vehicle is located at the predetermined point, e.g., the endpoint, of the road segment. Thus, the precise position of the vehicle along the road at one point in time (e.g., the time-point of maximum correlation) may be determined as it coincides with the predetermined point of the road segment. In optional block 310, further movement of the vehicle after the time point in block 308, and prior to the identification of the predetermined point of the next road segment, may be tracked using dead reckoning to approximate the position of the vehicle, thus returning the process to block 300 illustrated in FIG. 3.

Alternatively, the method may return to block 300 without dead reckoning, as the present disclosure is not so limited. In some embodiments, as the vehicle approaches the endpoint of the subsequent road segment, the method of FIG. 3 may be repeated until the vehicle is precisely located at the endpoint or other predetermined point of the subsequent road segment, and so on as the vehicle traverses any number of road segments. Thus, the vehicle may be precisely located, for example, each time it crosses a road segment endpoint or other predetermined point. In some embodiments, distinctive anomalies or road surface characteristics on a road may alternatively or additionally be used as predetermined points to locate a position of a vehicle as it travels along the road.

According to the embodiment of FIG. 3, the method may be performed, in some embodiments, by a processor configured to executed computer-readable instructions, e.g., stored in non-transitory memory. For example, the method of FIG. 3 may be stored as a series of instructions in non-transitory computer memory for execution by a processor. In some embodiments, the method of FIG. 3 may be performed by a vehicle processor (e.g., see processor 152 in exemplary FIG. 2).

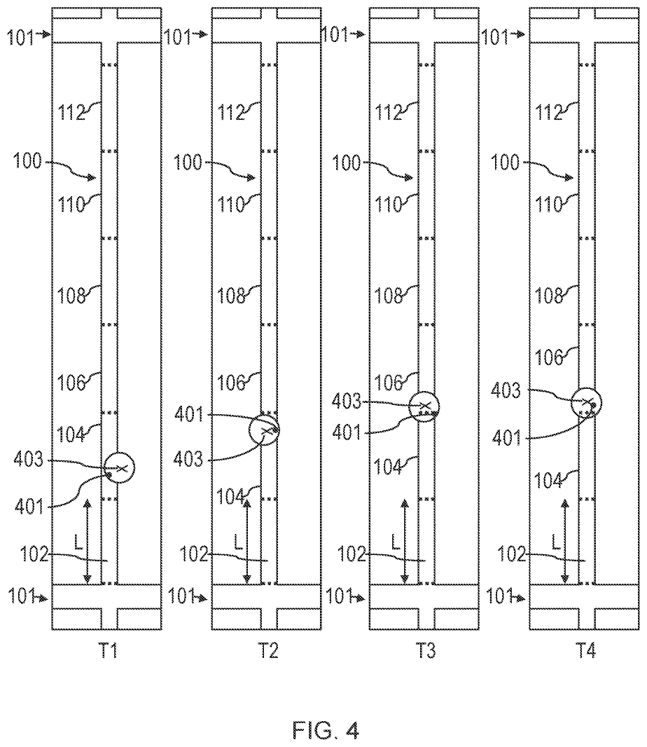

FIG. 4 illustrates a method of terrain-based localization of a vehicle according to an exemplary embodiment as a vehicle travels along a road 100 divided into a plurality of road segments 102, 104, 106, 108, 110, 112. The dots 401 at each time T1-T4 represent the true location of the vehicle, which is generally unknown but shown for clarity. The letter “X” 403 in each time represents the location of the vehicle as approximated by a first localization system (e.g., by GNSS, dead reckoning, or other location approximation systems), while the circle around the X represents the potential region of uncertainty, i.e. the range of actual locations determined by the accuracy of the first localization system. As shown in FIG. 4, the approximate location may differ somewhat from the true location due to resolution limitations of GNSS or other systems. The true location of the vehicle may be, but is not necessarily in the region of uncertainty. Note that, while the “X” is used here to represent the location approximated by GNSS, it could also represent a location approximated by dead reckoning or other first localization method or system.

As shown in FIG. 4, at the first point in time, denoted T1, in an exemplary embodiment, the location of the vehicle may be approximated as being within a second road segment 104, but not near the endpoint (represented as a dashed line) of the second road segment 104. Thus, in this embodiment, at time T1, if the current road surface profile that terminates at the current location 401 of the vehicle at T1 may not correlate well with the reference profile of the second road segment 104, which terminates at the endpoint of road segment 104. Therefore, time T1, rather than using terrain-based localization, the location of the vehicle may be continually or periodically approximated by other less computationally intensive localization methods (e.g., by GNSS localization and/or dead reckoning).

As shown in FIG. 4, at a second, subsequent point in time, T2, the approximate location of the vehicle (e.g., as reported by using a GNSS receiver) may be determined to be within a predefined threshold distance from a preselected point in the road, e.g. the endpoint of the second road segment 104. As a result, terrain-based localization may be used to determine the location of the vehicle more precisely than, for example, by using GNSS or dead reckoning. In the embodiment illustrated in FIG. 4, at T2, terrain-based localization may be implemented by comparing appropriate portions of the reference and current road profiles. In FIG. 4, beginning at time T2, the previous or trailing L meters of the current road surface profile may be compared (e.g., continuously or periodically) with the reference road surface profile that terminates at the endpoint of the second road segment. After it has been determined that the vehicle is within the threshold distance of the endpoint of road segment 104, the current road surface profile may be continually or periodically updated as the vehicle moves towards the preselected point. On multiple occasions, the current road surface profile of length L that trails the vehicle may be updated and the updated current road surface profiles may be compared to the reference road surface profile of equivalent length that terminates at the preselected point. For example, as illustrated in FIG. 4, in some embodiments, a portion of a current road surface profile of the predetermined length may be compared to a portion of the reference road surface profile of equivalent length.

As the vehicle approaches the endpoint of the segment, the correlation between the current road surface profile and the reference road surface profile will increase. Therefore, the actual location of the vehicle will coincide with the endpoint of the second road segment 104 (illustrated as time T3 in FIG. 4), when the correlation between the current road surface profile of length L meters and the reference road surface profile of equivalent length associated with road segment reaches a maximum value. Thus, by determining the time and/or position of the vehicle where the current and reference road surface profile exhibit maximum correlation, or if the correlation exceeds a threshold (e.g., by peak detection and/or a correlation threshold), the location of the vehicle along the road 100 may be precisely determined (at least, within an accuracy better than that of the first localization system) as coinciding with the endpoint of the second road segment 104 at that time (e.g., T3).

Following this precise determination of the location of the vehicle, localization of the vehicle may revert back to relying on dead reckoning, GNSS, or other methods may then be used to track further movement of the vehicle, as shown in T4. This dead-reckoning and/or GNSS localization may continue until the vehicle is determined to be at or sufficiently near the another preselected point, e.g. the endpoint of the next road segment (e.g., a third road segment 106), when the process may be repeated for subsequent road segment as the vehicle traverses any number of road segments.

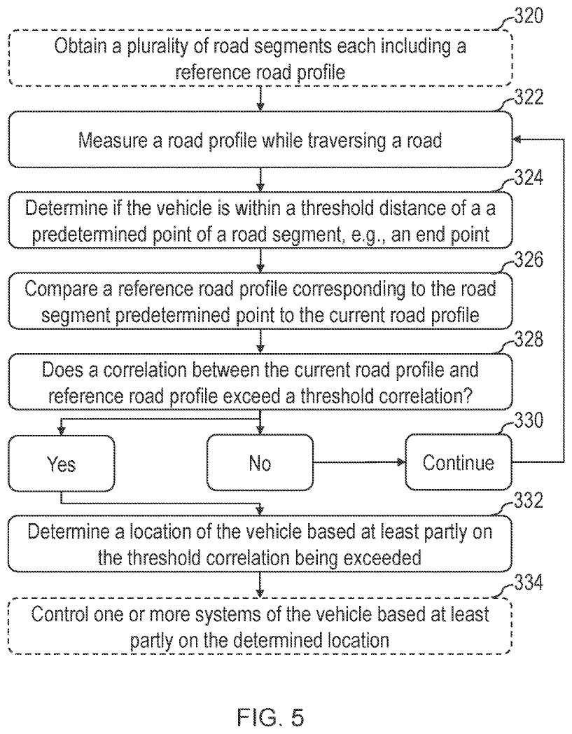

With regard to FIG. 5, it is noted that the pre-determined a point in one or more road segments may be a point with a known location other than the endpoint. Accordingly, the comparison of current road surface profile and the reference profile may be for a appropriate length that is less than the current road segment length “L.”

FIG. 5 depicts a flow chart for another embodiment of a method of localizing a vehicle utilizing a terrain-based localization system. In optional block 320, data associated with a plurality of road segments may be obtained (e.g., downloaded) where data associated with each road segment includes at least one reference road surface profile. In some embodiments, the road segments may be downloaded from a remote server via a wireless network. In block 322, a current road surface profile is determined while traversing at least a portion of a road segment. For example, vertical wheel motion and/or vertical motion of the vehicle body may be measured using one or more sensors and the road surface profile may be based on the input of the one or more sensors. In block 324, it is determined if the vehicle is within a threshold distance of predetermined point of a road segment, e.g., the road segment endpoint, mid-point, or other preselected point in the road. This determination may be based on an approximate location via approximate localization techniques such as, e.g., GNSS and/or dead reckoning relative to a previously known location of a vehicle. In block 326, a reference road surface profile is compared to the current road surface profile of equivalent length. For example, the reference road surface profile and current road surface profile may be cross correlated to determine a correlation of the reference road surface profile and current road surface profile. In block 328, it is determined if a correlation between the current road surface profile and the reference road surface profile exceed a threshold value or magnitude. For example, the correlation (e.g., a number between 0 and 1), may be compared against a predetermined correlation threshold (e.g., greater than or equal to 0.5, 0.6, 0.7, 0.8, or 0.9). If the correlation does not exceed the threshold, the method may continue at block 330 and restart at block 322. If the correlation exceeds the threshold, the location may be determined based on the threshold correlation being exceeded in block 332. In some embodiments, the method may also include determining if the correlation is a peak correlation before determining that the location of the vehicle corresponds to the time point or position where the correlation exceeds the threshold correlation. In optional block 334, one or more systems of the vehicle may be controlled based at least partly on the determined location and/or the road surface profile of the road segment ahead of the vehicle. For example, in some embodiments a suspension system of a vehicle may be controlled based at least partly on the determined location. In some embodiments, the one or more systems may also be controlled based on a position of the vehicle determined using the terrain-based localization followed by less precise localization using dead reckoning or GNSS. By using a combination of terrain-based localization and other less precise localization, such as GNSS or dead reckoning, acceptable overall vehicle localization accuracy may be achieved while reducing the need for computational resources.

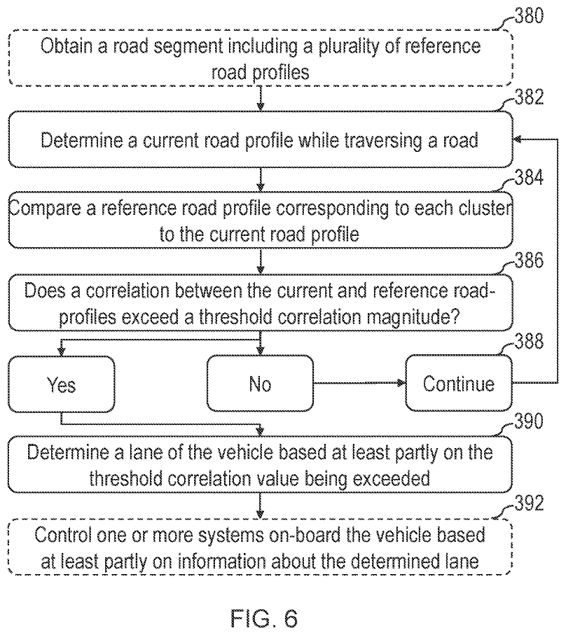

FIG. 6 is a flow chart for another embodiment of a method of localizing a vehicle with a terrain-based localization system. In particular, the method of FIG. 6 may be employed to localize the vehicle to a position on a specific track of a particular road segment. In optional block 380, a road segment including a plurality of reference road-profiles corresponding to different tracks in the road segment may be obtained. For example, the road segment may be downloaded to or otherwise made available to an on-board processor of a vehicle from a local or remote server. In block 382, a current road surface profile may be determined for at least a portion of the road segment while the vehicle traverses a lane in a road-segment. In block 384, the current road surface profile may be compared to each reference road surface profile corresponding to each cluster of the road segment. In some embodiments, the comparisons of block 384 may be triggered by an approximate location of a vehicle being within a threshold distance of the road segment endpoint or other predetermined point, as described with reference to other exemplary embodiments herein. In some embodiments, the comparisons of block 384 may be a cross-correlation of the current and reference road surface profiles. In block 386, it is determined if a correlation between the current road surface profile and a reference road surface profile exceeds a threshold correlation. For example, the correlation (e.g., a number between 0 and 1), may be compared against a predetermined threshold correlation (e.g., greater than or equal to 0.5, 0.6, 0.7, 0.8, or 0.9). If the threshold is not exceeded, the method continues in block 388 and restarts at block 382. If the threshold is exceeded, in block 390 the track of the vehicle may be identified based on the threshold correlation being exceeded between a current road surface profile and a reference road surface profile associated with a particular cluster. In optional block 392, one or more systems of the vehicle, e.g. active suspension, semi-active suspension, steering, and/or braking systems, may be controlled based at least partly on road surface profile information associated with the determined track that the vehicle is traveling along.

According to the embodiment of FIG. 6, the method may be performed, in some embodiments, at least partially, by a remote or on-board processor configured to executed computer-readable instructions stored in non-transitory memory. For example, the method of FIG. 6 may be stored as a series of instructions in non-transitory computer readable memory for execution by a processor. In some embodiments, the method of FIG. 6 may be performed by a vehicle processor (e.g., see processor 152 in exemplary FIG. 2).

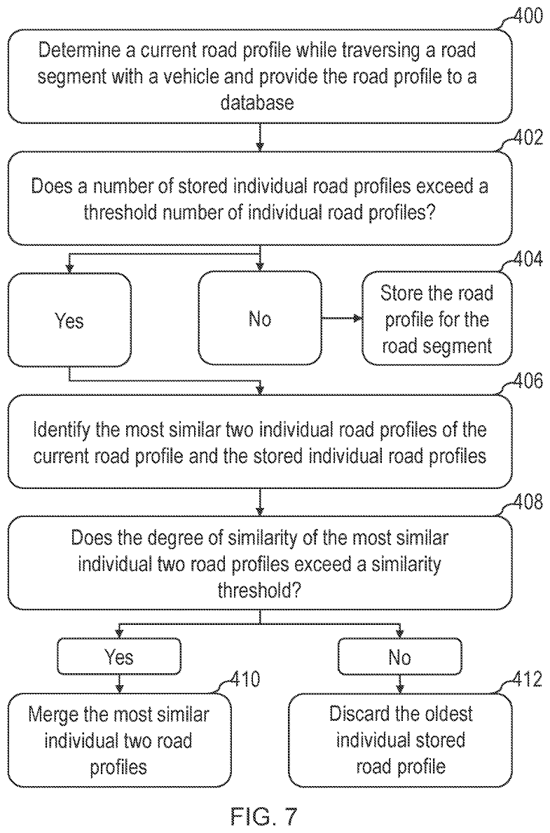

FIG. 7 depicts a flow chart for another embodiment of collecting a plurality of road surface profiles for a multi-track road segment for terrain-based localization. In particular, FIG. 7 depicts a method for defining a road segment with multiple tracks without explicitly or necessarily running a clustering algorithm to cluster a pre-existing set of road surface profiles. In block 400, a road current profile is determined based on information gathered while traversing a road segment. Alternatively, in some embodiments, the method may include obtaining a current road surface profile from a vehicle that transmits the measured data to a remote database. In block 402, it is determined if a number of individual stored road surface profiles exceeds a predetermined threshold number of road surface profiles (e.g., between 4 and 64 road surface profiles). If the threshold is not exceeded, the measured road surface profile may be stored in block 404. If the threshold is exceeded, the method may include identifying the most similar two (or more) road surface profiles of the measured road surface profile and stored road surface profiles in block 406. In some embodiments, the two or more most similar road surface profiles may be determined by determining a degree of similarity between each of the road surface profiles and selecting the road surface profiles with the greatest degree of similarity. The two most similar road surface profiles may be stored road surface profiles or may be the measured road surface profile and a stored road surface profile. In block 408, it is determined if the degree of similarity of the two (or more) most similar road surface profiles exceeds a similarity threshold. For example, the degree of similarity, which may be determined using cross correlation, e.g., a number between 0 and 1, may be compared against a predetermined similarity threshold (e.g., greater than or equal to 0.5, 0.6, 0.7, 0.8, or 0.9). If the degree of similarity exceeds the threshold, in block 410 the two (or more) most similar road surface profiles are merged (e.g., averaged). If the degree of similarity does not exceed the threshold, the oldest of the set of stored or previously recorded road surface profile may discarded in block 412. In some embodiments, the oldest stored road surface profile may only be discarded if it is not a merged road surface profile. In such cases, the oldest unmerged road surface profile may be an outlier. In some embodiments the oldest merged road surface profile may be discarded, as the present disclosure is not so limited. According to the embodiment of FIG. 7, the method may be performed, in some embodiments, by a processor configured to executed computer-readable instructions stored in non-transitory memory. For example, the method of FIG. 7 may be stored as a series of instructions in non-transitory computer readable memory for execution by a processor. In some embodiments, the method of FIG. 7 may be performed by a server processor (e.g., see server 250 in exemplary FIG. 2).

Inventors have recognized that, alternatively or additionally, when determining the location of a vehicle, the current and the reference road surface profiles may be compared continuously or at frequent intervals without incurring substantial computational overhead. These road surface profiles may be compared efficiently by calculating the running correlation between a real-time road surface profile current data set and previously collected reference road surface profile data set at multiple relative alignments of the two data sets. In this Continuous Correlator method, at a particular point in time, the position of the vehicle may be assumed to be at a number of potential locations relative to the reference profile. At each of these locations (hereinafter referred to as nodes), a running correlation may be calculated. The node or alignment with the highest correlation may be a best estimate of the location of the vehicle in the road segment.

As a vehicle travels along a road, stored reference road surface profile data for the road may be accessed by a processor which may be on board the vehicle or located at a remote location. A localization system on-board the vehicle (such as for example GNSS or dead reckoning from a previously determine location) may be used in real-time to estimate the current location of the vehicle relative to the previously determined reference road surface profile.

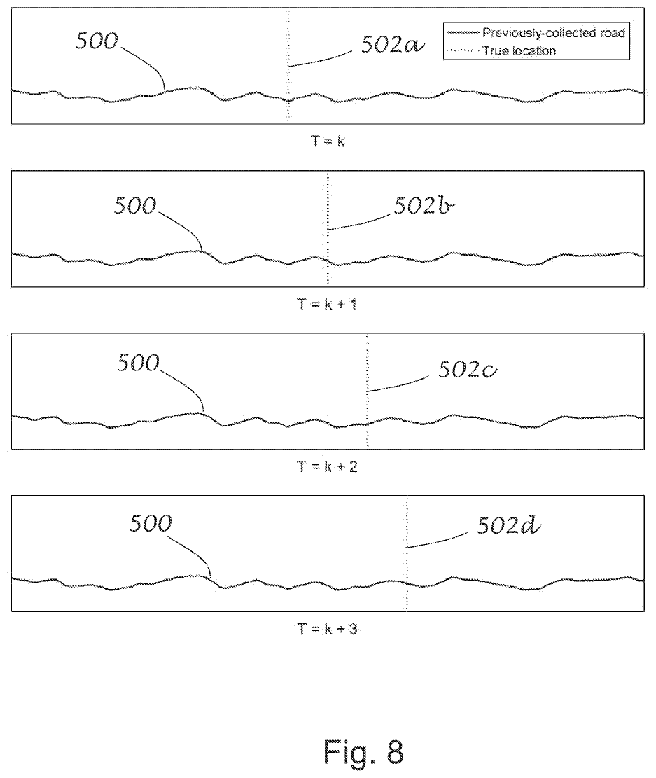

FIG. 8 illustrates an example of where the position of a vehicle is shown at different time steps relative to a reference road surface profile. The solid line 500 represents a previously-collected reference road surface profile, while the dotted lines 502a, 502b, 502c, and 502d represent the true location of a vehicle (not shown) at four different points at time T=k, k+1, k+2, and k+3, respectively, as the vehicle travels along the road. The vehicle may also use on-board sensors to determine the current road surface profile in real-time.

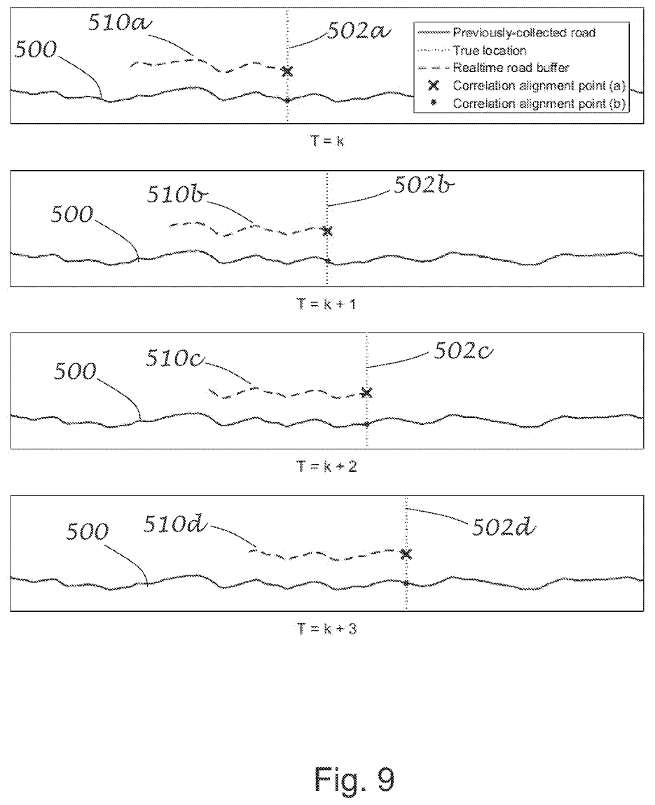

In FIG. 9, the dotted lines 510a, 510b, 510c, and 510d represent current road surface data which may be obtained in real-time using sensors on-board when the vehicle (not shown) is at locations 502a, 502b, 502c, and 502d. The current road surface profile that may trail the vehicle may be stored in a buffer on-board the vehicle or at a remote location. In some embodiments the buffer may be, for example, a buffer of length N (e.g., N=500). As the vehicle travels along a road, at each timestep, a new road surface measurement may be added to the buffer and the oldest measurement in the buffer may be discarded. Buffers may also be used where N is in the range of 300 to 700. Values of N both greater than and less than the range noted above are also contemplated as the disclosure is not so limited.

In the example illustrated in FIG. 9, the correlation coefficient at each timestep (T=k, k+1, k+2, and k+3) between the current road surface profiles (510a-510d) and the corresponding segments of equivalent length of reference road surface profile 500 may be determined. If the position of the vehicle at each time step is know precisely, the correlation coefficients so determined will be high and may approach or be equal to 1 or 100%. In some embodiments, the magnitude of the correlation coefficient may be used as an indication of the accuracy of the current position of the vehicle.

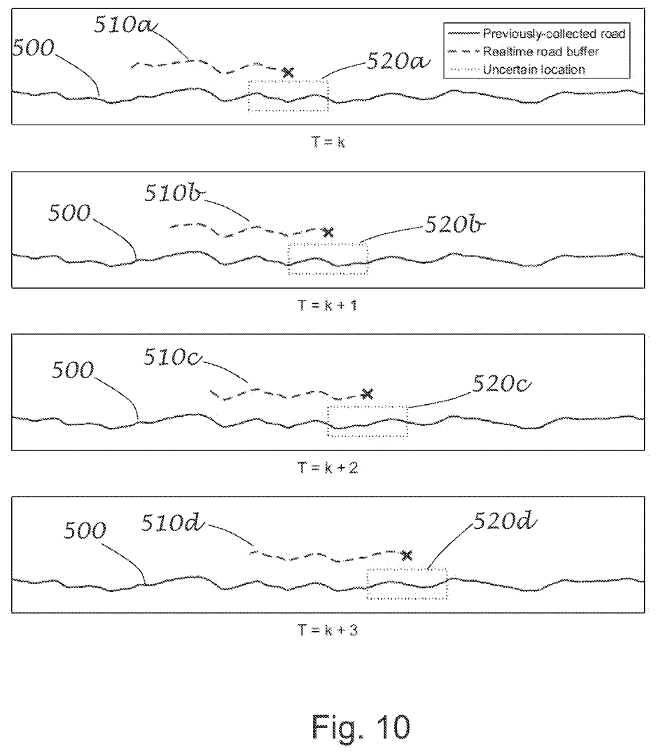

The example illustrated in FIG. 10 is a duplicate of FIG. 9 except that in this case the position of the vehicle is not known precisely. The range of uncertainty of the position of the vehicle is represented by rectangles 520a, 520b, 520c, and 520d at times steps T=k, k+1, k+2, and k+3, respectively. In the example in FIG. 10, the vehicle's location is indicated as a range rather than a definite point, as in the example of FIG. 9. In some embodiments the approximate position of the vehicle may be determined by a GNSS system or a dead reckoning system and the ranges 520a-520d may represent the typical measurement error of a GNSS or the dead reckoning error, or the confidence window from a Kalman filter, etc.

In the example of FIG. 10, e.g. at time step T=k, the magnitude of the correlation coefficient between current road surface profile 510a and the corresponding portion of reference road surface profile 500 will depend on the assumed position of the vehicle in the range of uncertainty 520a. Accordingly, at any given time-step, the assumed position of the vehicle in the range of uncertainty will determine the alignment of current road surface profile data and the corresponding portion of the reference road surface profile data.

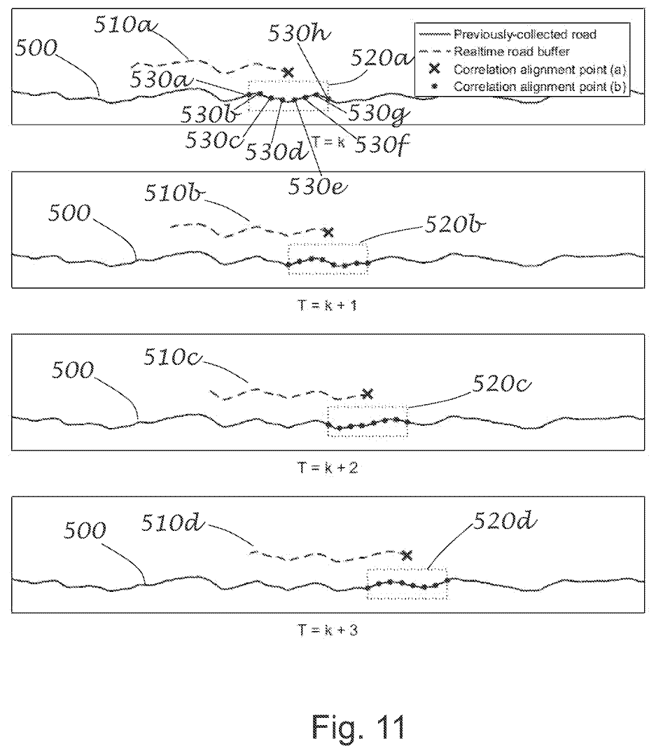

In some embodiments, since the precise location of the vehicle in the range of uncertainty may not be known, multiple correlation coefficients may be determined for a given current road surface profile (510a-510d) by assuming that the vehicle is located at various points in the range of uncertainty. For example, as illustrated in FIG. 11, at time step T=k, when the vehicle is determined to be in the range of uncertainty 520a, for example based on using GNSS or other appropriate localization system, the vehicle may be assumed to be at any one of eight different locations 530a, 530b, 530c, 530d, 530c, 530f, 530g, and 530h. In the embodiment of FIG. 11, the assumed locations at any time step (T=k, k+1, k+2, and k+3) may be distributed throughout the range of uncertainty. They may be distributed uniformly, randomly, or according to an appropriate probability distribution, etc. FIG. 11 shows a uniform distribution of the potential locations of the vehicle in time steps T=k to T=k+3. The number of assumed locations of the vehicle in the range of uncertainty may be greater than or equal to three and less than or equal to 20. Of course, number of assumed locations both greater than and less than those noted above are also contemplated, as the disclosure is not so limited.

In the embodiment illustrated in FIG. 11, the same current road surface profile 510a. e.g. the most recent current road surface profile data, may correlated with a portion of the reference road surface profile 500 that is of equal length but that trails behind the assumed vehicle position 530a to 530h.

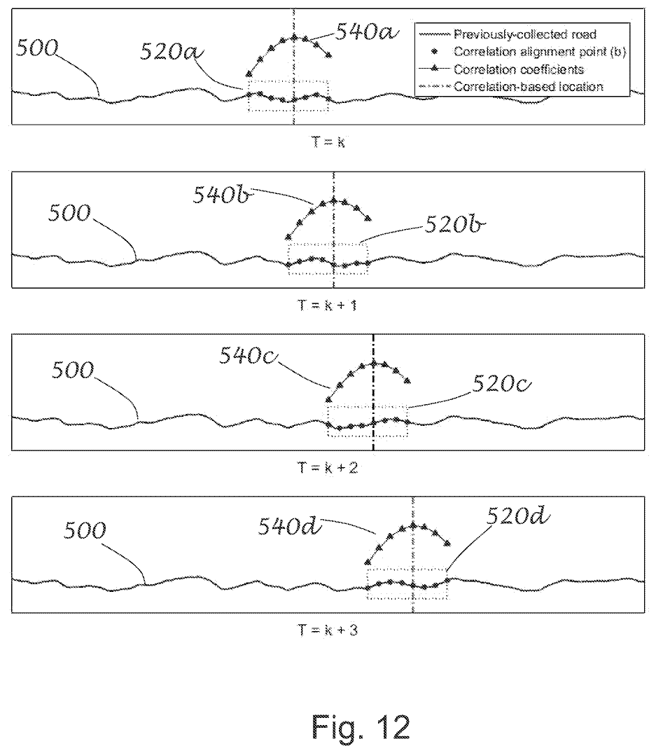

FIG. 12 illustrates exemplary distributions of correlation coefficients 540a-540d for the ranges of uncertainty 520a-520d, respectively. A single correlation coefficient (triangle) corresponds to each correlation alignment point determined at the assumed position of the vehicle relative to the reference profile 500. In the example shown in FIG. 12, the distribution of the coefficients form a rounded curve with a peak. The location of the maximum of this curve may represent the best (most highly correlated) alignment between the real-time current road surface profile 510a and the previously-collected reference profile 500. It can therefore be used as a real-time localization signal to determine position of the vehicle, relative to the reference profile, on a continuous or effectively continuous basis.

In some embodiments, a value of the peak close to 1 or 100% may represent a good match between current and previously-determined reference data indicating the likely position of the vehicle. But if the value begins to drop significantly, it may indicate a less reliable localization. For example, lower values of the peak may occur if the road has, for example, been repaved or the vehicle has changed lanes and thus the previously-collected reference profile may no longer be appropriate, e.g., for proactive control of various vehicle systems such as active suspension, propulsion, steering, or braking.

If separate road surface profiles have been collected or are available for various lanes or tracks of a road or road segment, an embodiment of the continuous correlator may be used for processing multiple profiles simultaneously. In such a case, the highest peak correlation among various lanes or tracks may correspond to the lane in which the vehicle is traveling and where the current road surface profile is determined. If the vehicle changes lanes from a first lane or track to a second lane or track, the peak in the first lane or track may begin to drop while the peak in another lane's correlator may begin to rise. This behavior may be used as an indicator that a lane change has occurred as well as to determine which lane the vehicle is changing to.

Accordingly, the methods disclosed herein, with regard to continuous longitudinal localization (“one-dimensional continuous correlation”), may be expanded to allow a degree of lateral localization continuous correlation (“two-dimensional continuous correlation”). When performing only one-dimensional localization, a running measure of correlation may be maintained at various longitudinal locations or positions along a reference road surface profile. To expand this to allow lateral localization, a similar measure of correlation may be maintained not just along a single road surface profile, but also for other road surface profiles that represent various lanes or tracks on the given road segment. By maintaining running correlations for multiple the potential lanes or tracks on a given road or road segment, the most likely lateral position of the vehicle may be identified as the one with the highest peak correlation.

Since number of correlation calculations grow with the number of lateral tracks or lanes, the computational burden may increase significantly on roads with multiple lanes or tracks. To reduce this burden, once the vehicle's current lane has been identified, correlation calculations for lateral tracks that are not laterally adjacent to the current lane may be discontinued.

Lane changes may be identified by detecting that the peak correlation has dropped in what was previously identified as the current lane/track and that peak correlation may be rising in a different track or lane. When this occurs, lanes/tracks previously considered to be adjacent tracks may also change so that future lane changes can also be detected.

A naïve implementation of the continuous correlator may require a large number of computations. The equation for the correlation coefficient between vectors a and b of length n may be determined by using the following equation:

$$c = \frac{{\sum }_{i = 1}^{n} {a}_{i} {b}_{i}}{\sqrt{( {\sum }_{i = 1}^{n} {a}_{i}^{2} ) \cdot ( {\sum }_{i = 1}^{n} {b}_{i}^{2} )}}$$

This may require approximately 6n operations. In some embodiments the value of n may be greater than or equal to 200 and less than or equal to 1000. Values of n both greater than and less than the range noted above are also contemplated as the disclosure is not so limited. If n=500 then a single correlation coefficient calculation may require approximately 3000 operations.

In some embodiment of the continuous correlator, multiple coefficients may need to be recalculated at each timestep. The number of coefficients needed may depend on the size of the uncertainty window and desired distribution density. The number of coefficients may be between 10 and 100. Number of coefficients both greater than and less than the range noted above are also contemplated, as the disclosure is not so limited. If the number of coefficients is 50, it would scale the number of operations up to 150,000 operations per update. In some embodiments, with such a number of operations per update, updates at 50 Hz or 100 Hz may not be feasible on certain microprocessors.

In some embodiments, the computational burden may be mitigated by replacing the naïve correlation coefficient with a running calculation. This may be achieved by replacing each of the three sums in the above equation with running averages. The equation that may be utilized is:

$$c = \frac{{R}_{n} ( ab )}{\sqrt{{R}_{n} ( {a}^{2} ) \cdot {R}_{n} ( {b}^{2} )}}$$

Rn represents a running average of length n. Each timestep, the three running averages may be updated with the latest point. Running averages are significantly more computationally efficient, and no longer scale with “n”. Instead, this new formulation only involves approximately 10 operations per timestep. These assumptions nay reduce the number of operations by a factor of approximately 300, making it reasonable even with less powerful hardware.

A downside of using running averages may be that each running average requires memory to store a buffer of length “n”. This may result a need for more memory for 3n points per coefficient or 75,000 total points.

In some embodiments, the computational burden may also be mitigated by replacing the running averages with infinite impulse response (IIR) filters. A running average may be considered to be a finite-impulse response low-pass filter. In some embodiments, the running average may be approximated with a first-order or second-order butterworth low-pass filter.

As a result, the equation for each correlation coefficient may be determined by the following equation:

$$c = \frac{F ( ab )}{\sqrt{F ( {a}^{2} ) \cdot F ( {b}^{2} )}}$$

F is an appropriately-designed IIR filter which approximates the running average. The advantage of the butterworth filter (or another similar IIR filter) is that it doesn't need to store a buffer of length “n” but results in an acceptable approximation.

With a first-order butterworth, the storage needs may be reduced to a single value per filter for a total of 450 points (reduced from 75,000). This improvement may be at the expense of a minor increase in computation to roughly 20 operations per update.

Whether using running averages or IIR filters for the correlation calculation, a warmup period may be required either to fill the running average's buffer or to let the IIR filter transients settle out. During this period, the continuous correlator output may be noisy or unreliable. This warmup period may last a few seconds, e.g., 0.1 to 5 seconds.

In the example illustrated in FIG. 12, the correlation nodes are distributed uniformly in the range of uncertainty. In some embodiments, the distribution may be varied over time. For example, initially, e.g. during startup of the Continuous Correlator, the nodes may be distributed uniformly across the entire uncertainty range but with fairly generous spacing between nodes so as to limit the number of nodes (and thus limiting computational limits). As the correlator warms up, the correlator may begin to determine the vehicle's location more precisely. In that case, nodes far away from the peak correlation may be dropped and new nodes may be added near the peak to improve localization resolution.

In some embodiments, the correlation peak may drift relative to the nodes over time due to inaccuracies, e.g., in dead reckoning. As the correlation peak drifts, a node may be deleted from one side and added to the opposite side of the peak in order to recenter the correlation peak relative to the nodes.

In some embodiments, the warmup process for new nodes may be accelerated by initializing their states using their nearest neighboring nodes. Localization resolution may also be improved further by fitting a quadratic curve to the correlation coefficient curve and finding the peak of the resulting parabola. In this way the peak may be estimated even if it lies between two correlation nodes rather than directly at one of the nodes.

In some embodiments, the road surface profiles may be filtered, prior to calculating correlation coefficients by, e.g., using a bandpass filter. The same filter may be applied to both the current and previously-collected reference profiles.

The Continuous Correlator as described herein compares a real-time or current profile with a previously-collected profile. In some embodiments, the real-time front profile may be compared with the real-time rear profile. This comparison may be used as a diagnostic to ensure the road is estimated the same at both axles. It also be used to estimate of the true vehicle speed using the known distance between front and rear axles.

The Continuous Correlator may be used to quickly detect a decrease in profile similarity, before reaching the next track during a lane change, and thus, more promptly, attenuate or disable algorithms that control various vehicle systems, that rely on localization, more promptly. Since in some embodiments, nodes may be dynamically placed provides more flexibility depending on the level of localization uncertainty or the desired localization resolution. This may be beneficial at low speeds.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of accurately determining a current location of a vehicle traveling along a road, the method comprising:
with the vehicle, traveling along a first road segment to arrive at the current location of the vehicle;
receiving a current road-surface profile of the first road segment, wherein the first road segment terminates at the current location of the vehicle;
with a localization system (e.g., GNSS, GPS), determining that the current location of the vehicle is within a zone of uncertainty of the localization system;
from a data storage system (e.g., local RAM, remote database) obtaining reference road-surface profiles for a multiplicity of road segments, wherein each of the multiplicity of road segments is equal in length to the first road segment, and wherein each of the multiplicity of road segments has an endpoint located in the zone of uncertainty;
comparing each of the multiplicity of reference road-surface profiles with the current road-surface profile; and
determining an accurate current location of the vehicle, at least partially based on the comparison.

2. The method of claim 1, wherein the multiplicity is a number greater than 2 but less than 20.

3. The method of claim 1, wherein the comparing involves computing a magnitude of a correlation between each pair of road surface profiles, wherein each pair includes one of the multiplicity of reference road-surface profiles and the current road surface profile.

4. The method of claim 3, further comprising determining a maximum of the computed correlations and determining the accurate current location of the vehicle to be the segment endpoint associated with the correlation with the maximum value.

5. The method of claim 1, wherein each reference road-surface profile is at least partially based on crowd sourced data.

6. The method of claim 1, wherein the comparing involves using running averages of the current and/or reference data sets.

7. The method of claim 1, wherein the comparing involves applying a filter to the current and/or reference data sets.

8. The method of claim 7, wherein the filter is an IIR filter.

9. The method of claim 1, wherein the current road-surface profile and a first reference road-surface profile include an equal number of data points, and wherein the comparison includes determining a degree of similarity between at least the first reference road-surface profile and the current road-surface profile at least based on a running average of the squares of the data points in each of the first reference road-surface profile and the current road-surface profile.

10. (canceled)

11. A method for localizing a vehicle, the method comprising:
obtaining an approximate location of the vehicle;
determining that the approximate location is within a threshold distance of a pre-determined point of a first road segment of a series of road segments, wherein the first road segment is associated with a first reference road surface profile; and
comparing a current road surface profile with the first reference road surface profile and, based on the comparison of the current road surface profile with the first reference road surface profile, determining a first time-point at which the vehicle is located at the pre-determined point of the first road segment, thereby localizing the vehicle to the pre-determined point of the first road segment at the first time-point.

12. The method of claim 11, wherein obtaining the approximate location of the vehicle is based at least in part on a Global Navigation Satellite System (GNSS) location of the vehicle.

13. The method of claim 11, wherein obtaining the approximate location of the vehicle is based at least in part on dead reckoning.

14. The method of claim 11, further comprising obtaining for each road segment:
a pre-determined point location of the respective road segment; and
a reference road surface profile of the respective road segment.

15. The method of claim 14, further comprising using dead-reckoning to track further movement of the vehicle after the first time-point.

16. The method of claim 11, further comprising generating the current road surface profile.

17. The method of claim 16, wherein generating the current road surface profile comprises measuring vertical motion of one or more portions of the vehicle as the vehicle operates.

18. The method of claim 17, wherein generating the current road surface profile further comprises filtering the current vertical motion to remove effects of wheel-hop.

19. The method of claim 17, wherein generating the current road surface profile further comprises differentiating the current vertical motion with respect to time or distance.

20. The method of claim 17, wherein generating the current road surface profile further comprises transforming the current vertical motion from a time domain to a distance domain.

21. The method of claim 11, wherein the comparison of the current road surface profile with the first reference road surface profile is carried out in response to the determination that the approximate location is within a threshold distance of the pre-determined point of the first road segment.

22-32. (canceled)
